(19) United States
(12) Patent Application Publication
(10) Pub. No.: US 2011/0022720 A1
(43) Pub. Date: Jan. 27, 2011

(54) NETWORK MANAGING METHOD, DEVICE, AND SYSTEM

(75) Inventors: Jongtae SONG, Daejeon (KR); Young Boo KIM, Gongju-si (KR); Jinoo JOUNG, Seoul (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATIONS RESEARCH INSTITUTE, Daejeon (KR); INDUSTRY ACADEMIC COOPERATION FOUNDATION, SANGMYUNG UNIVERSITY, Cheonan-si (KR)

(21) Appl. No.: 12/776,624

(22) Filed: May 10, 2010

(30) Foreign Application Priority Data
Jul. 27, 2009 (KR) 10-2009-0068534

(51) Int. Cl. G06F 15/16

(52) U.S. Cl. 709/232

(57) ABSTRACT

A managing device according to the present invention is a management device of a network controllable by a flow aggregate (FA), and it includes a parameter information receiver for receiving control information on the FA from an upper node, a parameter generator for receiving an FA parameter according to the control information, and a parameter transmitter for transmitting the FA parameter generated by the parameter generator to another node.

### CROSS-REFERENCE TO RELATED APPLICATION

This application claims priority to and the benefit of Korean Patent Application No. 10-2009-0068534 filed in the Korean Intellectual Property Office on Jul. 27, 2009, the entire contents of which are incorporated herein by reference.

### BACKGROUND OF THE INVENTION

(a) Field of the Invention

The present invention relates to a network managing method, device, and system.

(b) Description of the Related Art

Quality of service (QoS) represents a method for differentiating service levels according to the priority of users or applications, and a QoS control technique is performed by controlling traffic and bandwidths within a limited bandwidth. The technique for controlling the traffic and bandwidths for the respective flows from among the QoS control techniques has an advantage of precise control, but it increases control loads by an increase of the number of flows when the capacity of the network is increased. The, it is difficult to apply the technique to a large capacity network.

Control techniques based on the flow aggregate (FA) are used for a huge network system so as to adjust the control load. Such FA-based control techniques includes a plurality of FA domains. Each FA domain uses control techniques such as the multi-protocol label switching (MPLS) scheme and differentiated service (diffserv) scheme, and the control technique for each FA domain can be different.

When the control techniques for the FA domain are different from each other, it is required to determine the possibility of guaranteeing the QoS by integrating information of the FA domain although a single session has passed.

However, information of the currently used FA domain only includes physical measurement value and includes no detailed network information. The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to efficiently manage the network by defining FA domain information of a network and efficiently exchange and transmit the same in the network.

An exemplary embodiment of the present invention provides a device for managing a network that is controllable per flow aggregate (FA), including: a parameter information receiver for receiving control information on the FA from an upper node; a parameter generator for generating an FA parameter according to the control information; and a parameter transmitter for transmitting the FA parameter generated by the parameter generator to another node.

The FA parameter includes a rule for mapping an identifier of a flow on an identifier of an FA, and a bandwidth setting or scheduling method for allocating a bandwidth to the FA.

The mapping rule and the bandwidth setting or scheduling method are applied to a plurality of FAs in a like manner.

The FA parameter includes: a number of the flows that are included in the single FA; a ratio of a maximum size of a packet vs. link capacity; a number of hops in a domain through which the FA is passed; and a maximum number of domains through which the FA is passed.

The FA parameter further includes: a ratio of a maximum value of the summation of sustainable transfer rates of a plurality of flows in the FA and the link capacity; a ratio of a maximum value of the summation of sustainable burst size of the plurality of flows in the FA and the link capacity; and a ratio of a minimum requirement of a service ratio vs. the summation of the sustainable transfer rates or a scheduling priority.

The FA parameter further includes a packet discard priority of the FA and a class of the FA.

Another embodiment of the present invention provides a system for managing a network that is controllable per flow aggregate (FA), including: a plurality of FA information management units for generating and managing an FA parameter for displaying control information of the FA; a plurality of FA information exchange units for receiving the FA parameter from the FA information management unit and storing the same; and an FA information gathering unit for receiving the FA parameter from the FA information exchange unit and integrating the same as the network information.

The plurality of FA information exchange units exchange the FA parameter with each other.

The FA information management unit is provided at an edge node of the FA domain.

The FA parameter includes: a rule for mapping an identifier of a flow on an identifier of an FA; a bandwidth setting or scheduling method for allocating a bandwidth to the FA; a number of the flows that are included in the single FA; a ratio of a maximum size of a packet vs. link capacity; a number of hops in a domain through which the FA is passed; a maximum number of domains through which the FA is passed; a ratio of a maximum value of the summation of sustainable transfer rates of a plurality of flows in the FA and the link capacity; a ratio of a maximum value of the summation of sustainable burst size of the plurality of flows in the FA and the link capacity; a ratio of a minimum requirement of a service ratio vs. the summation of the sustainable transfer rates or a scheduling priority; a packet discard priority of the FA; and a class of the FA.

The mapping rule and the bandwidth setting or scheduling method are applied to a plurality of FAs in a like manner.

Yet another embodiment of the present invention provides a management method by a flow aggregate (FA) information exchange unit for managing a domain of the FA in a network that is controllable per FA, including: receiving a request on an FA parameter for indicating control information of the FA from an FA information gathering unit for managing the network; requesting the FA parameter from an FA information management unit belonging in the FA domain; receiving the FA parameter from the FA information management unit; and transmitting the FA parameter to the FA information gathering unit.

The FA parameter is generated by the FA information management unit.

The receiving of a request includes receiving an identifier of a requester, and the requesting includes transmitting an identifier of the requester.

The receiving of a request further includes receiving an identifier of the FA, and the requesting further includes transmitting an identifier of the FA.

The receiving includes receiving an identifier of a responder.

The management method further includes receiving a report on the FA parameter from the FA information management unit, and reporting the FA parameter to the FA information gathering unit.

Yet another embodiment of the present invention provides a management method by a flow aggregate (FA) information exchange unit for managing a domain of the FA in a network that is controllable per FA, including receiving a report on an FA parameter from the FA information management unit, and reporting the FA parameter to the FA information gathering unit for managing the network.

The FA parameter is generated by the FA information management unit.

The reporting includes transmitting an identifier of a reporter.

According to the present invention, FA domain information of the network can be used by definition with detailed parameters, and the supportable QoS of the end-to-end service can be predicted by efficiently exchanging and collecting the same information in the network.

### BRIEF DESCRIPTION OF THE DRAWINGS

FIG. 1 shows a network management system according to an exemplary embodiment of the present invention.

FIG. 2 shows a block diagram of a flow aggregate (FA) information management unit according to an exemplary embodiment of the present invention.

FIG. 3 shows a flowchart of a network management method according to an exemplary embodiment of the present invention.

FIG. 4 shows a flowchart of a network management method according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may indicate a mobile station (MS), a mobile terminal (MT), a subscriber station (SS), a portable subscriber station (PSS), user equipment (UE), and an access terminal (AT), and it may include entire or partial functions of the mobile station (MS), the mobile terminal, the subscriber station, the portable subscriber station, the user equipment, and the access terminal.

In the specification, a base station (BS) may indicate an access point (AP), a radio access station (RAS), a nodeB (Node-B), an evolved Node-B (eNB), a base transceiver station (BTS), and a mobile multihop relay (MMR)-BS, and it may include entire or partial functions of the access point, the radio access station, the nodeB, the evolved Node-B, the base transceiver station, and the mobile multihop relay-BS.

A network management method, device, and system according to an exemplary embodiment of the present invention will now be described in detail with reference to accompanying drawings.

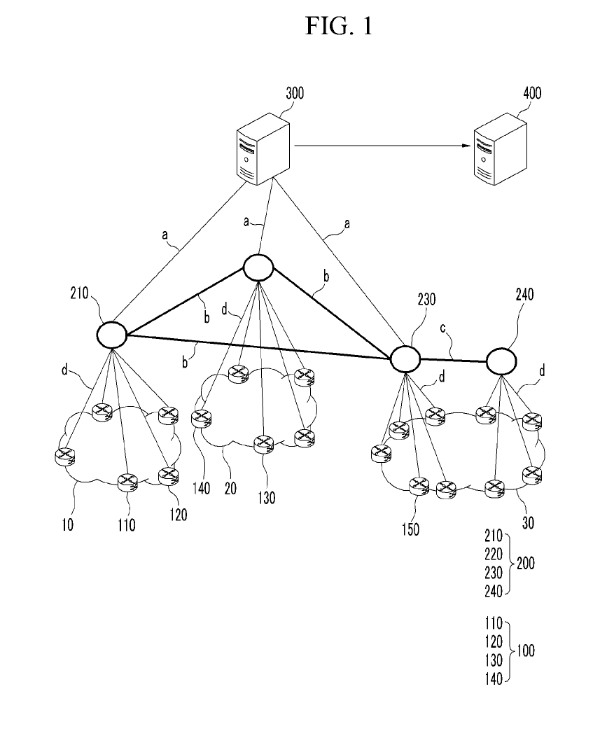

FIG. 1 shows a network management system according to an exemplary embodiment of the present invention.

Referring to FIG. 1, the network management system includes a plurality of flow aggregate (FA) information management units 100, a plurality of FA information exchange units 200, an FA information gathering unit 300, and a network management unit 400.

The FA information management unit 100 includes FA information management units 110 and 120 belonging to the FA domain 10, FA information management units 130 and 140 belonging to the FA domain 20, and an FA information management units 150 belonging to the FA domain 30.

The respective FA information management units 100 are provided at edge nodes of domains 10, 20, and 30, and generate and manage parameters having information on the respective FA domains (hereinafter, FA parameters.)

The FA information management units 100 can be included in a router.

A plurality of FA information exchange units 200 include an FA information exchange unit 210 belonging to the FA domain 10, an FA information exchange unit 220 belonging to the FA domain 20, and an FA information exchange unit 230 belonging to the FA domain 30. The respective FA domains 10, 20, and 30 have at least one FA information exchange unit 200, and the number of FA information exchange units 200 is variable by the sizes of the FA domains 10, 20, and 30.

The respective FA information exchange units 200 receive an FA parameter from the FA information management units 100 belonging to the corresponding domains 10, 20, and 30, and combine and store the same as FA domain information. The respective FA information exchange units 200 exchange the stored FA parameter as needed. The respective FA information exchange units 200 can be servers for managing the FA domains 10, 20, and 30.

The FA information gathering unit 300 gathers the FA parameters from the FA information exchange units 200 in the respective FA domains 10, 20, and 30, and combines them as network information.

The FA information gathering unit 300 gathers the FA parameters from the FA information exchange units 210, 220, and 230 through an interface (a). The FA information exchange units 210, 220, and 230 belonging to the different FA domains 10, 20, and 30 exchange the FA parameters through an interface (b), and the FA information exchange units 230 and 240 belonging to the same FA domain 30 exchange the FA parameters through an interface (c). The FA information exchange unit 200 receives the FA parameter from the FA information management unit 100 through the interface (a).

The network management unit 400 is a server for managing the network by controlling the FA information gathering unit 300.

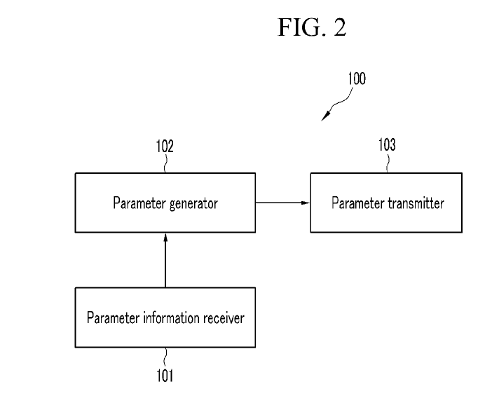

An FA information management unit according to an exemplary embodiment of the present invention will now be described in detail with reference to FIG. 2.

FIG. 2 shows a block diagram of an FA information management unit according to an exemplary embodiment of the present invention.

Referring to FIG. 2, the FA information management unit 100 includes a parameter information receiver 101, a parameter generator 102, and a parameter transmitter 103.

The parameter information receiver 101 receives FA control information from the network management unit 400.

The parameter generator 102 generates an FA parameter based on the FA control information received by the parameter information receiver 101. The FA parameters generated by the parameter generator 102 are shown in Table 1.

TABLE 1

| Number | Parameter contents |
|---|---|
| 1 | flow identifier and mapping rule of FA identifier |
| 2 | bandwidth setting method or scheduling method |
| 3 | number of flows in one FA |
| 4 | maximum packet size and link capacity ratio |
| 5 | number of hops of domain through which FA passes |
| 6 | maximum number of domains through which FA passes |
| 7 | maximum value of summation of sustainable transfer rates (Rs) |
| | of a plurality of flows in FA and ratio of the link capacity |
| 8 | maximum value of summation of sustainable burst sizes (Bs) |
| | of a plurality of flows in FA and ratio of link capacity |
| 9 | ratio of summation of minimum service ratio (bandwidth) and |
| | sustainable transfer rate (Rs) or scheduling priority |
| 10 | discard priority of FA packet |
| 11 | FA class |

Referring to Table 1, the parameter 1 represents the rule for mapping the flow and an appropriate FA applicable to all FAs of the same domain in a like manner.

In the parameter 2, the bandwidth is set so as to allocate a bandwidth to the FA, and the scheduler indicates weighted fair queuing (WEQ) or priority scheduling. The parameter 2 is also applicable to all FAs of the same domain in a like manner.

The parameters 3 to 11 are defined for each FA.

The parameter transmitter 103 transmits the FA parameter generated by the parameter generator 102 to the other FA information management unit 100 or the FA information exchange unit 200.

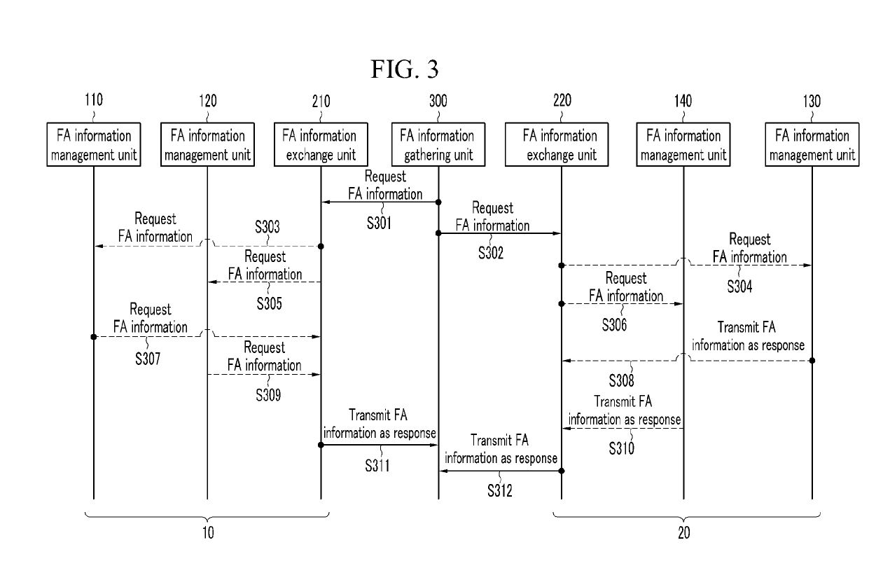

A network management method according to an exemplary embodiment of the present invention will now be described in detail with reference to FIG. 3.

FIG. 3 shows a flowchart of a network management method according to an exemplary embodiment of the present invention.

Referring to FIG. 3, the FA information gathering unit 300 requests FA information from the FA information exchange units 210 and 220 through the interface (a) S310 and S320. Here, the requests regarding the FA information of S310 and 320 are transmitted through an FA-information-request message. The FA-information-request message includes an identifier of the request, and may include an FA identifier for identifying the FAs such as the MPLS.

The FA information exchange units 210 and 220 use an interface (d) to request FA information from the FA information management units 110, 120, 130, and 140 S330, S340, S350, and S360. In this instance, the requests of the FA information of S330, S340, S350, and S360 are also transmitted through the FA-information-request message.

The FA information management units 110, 120, 130, and 140 use the interface (d) to respond to the FA information exchange units 210 and 220 with the FA information S307, S308, S309, and S310. In this instance, the responses on the FA information S307, S308, S309, and S310 are transmitted through the FA-information-response message. The FA-information-response message includes an identifier of the responder and FA parameters, and may include an FA identifier.

The FA information exchange units 210 and 220 use the interface (a) to respond to the FA information gathering unit 300 with the FA information S311 and S312. In this instance, the responses on the FA information S311 and S312 are transmitted through the FA-information-response message.

The FA information exchange units 210 and 220 can receive the FA parameters from the FA information management units 110, 120, 130, and 140, and the FA information exchange units 210 and 220 can exchange the FA parameters with other FA information exchange units 230 and 240 through the interfaces (b and c) by using the FA-information-request message and the FA-information-response message.

Accordingly, the operation shown in FIG. 3 is generally performed when an upper object requests information from a lower object or an equivalent object and the one of the lower object and the equivalent object responds to the upper object with information, and it is performed periodically or when a request is generated.

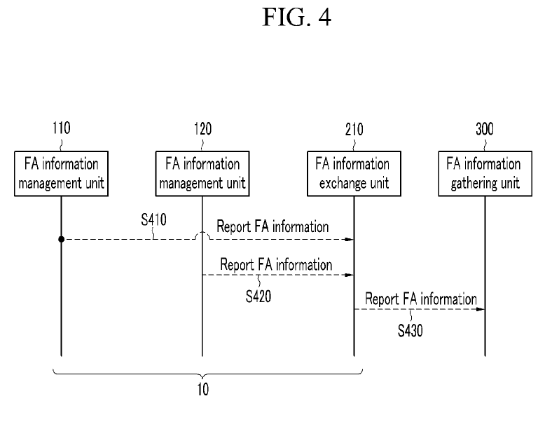

A network management method according to another exemplary embodiment of the present invention will now be described with reference to FIG. 4.

FIG. 4 shows a flowchart of a network management method according to another exemplary embodiment of the present invention.

Referring to FIG. 4, the FA information management unit 110 reports FA information to the FA information exchange unit 210 through the interface (d) (S410), and the FA information management unit 120 reports the FA information to the FA information exchange unit 210 (S420). In this instance, the reports on the FA information of S410 and S420 are transmitted through an FA-information-report message. The FA-information-report message includes a reporter identifier and an FA parameter, and may include an FA identifier.

The FA information exchange unit 210 analyzes the FA parameter provided by the FA information exchange unit 210, and reports FA information to the FA information gathering unit 300 through the interface (a) (S430). Here, the report on the FA information of S430 is transmitted through the FA-information-report message.

The FA information exchange unit 210 can exchange the FA parameter to other FA information exchange units 220, 230, and 240 through the interfaces (b and c) by using the FA-information-report message.

The operation of FIG. 4 is performed when a lower object reports information to an upper object or an equivalent object, and it is performed periodically or when the FA parameter is changed.

The method of FIG. 3 and the method of FIG. 4 can be performed simultaneously. For example, when the FA parameter is periodically transmitted according to the method of FIG. 3 and the FA parameter is simultaneously changed, it can be transmitted according to the method of FIG. 4. Also, the FA information management unit 100 transmits and receives the FA parameter to and from the FA information exchange unit 200 according to the method of FIG. 4, and the FA information exchange unit 200 periodically transmits and receives the FA parameter to and from the FA information gathering unit 300 according to the method of FIG. 3.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A device for managing a network that is controllable per flow aggregate (FA), comprising:
a parameter information receiver for receiving control information on the FA from an upper node;
a parameter generator for generating an FA parameter according to the control information; and
a parameter transmitter for transmitting the FA parameter generated by the parameter generator to another node.

2. The device of claim 1, wherein
the FA parameter comprises:
a rule for mapping an identifier of a flow on an identifier of an FA; and
a bandwidth setting or scheduling method for allocating a bandwidth to the FA.

3. The device of claim 2, wherein
the mapping rule and the bandwidth setting or scheduling method are applied to a plurality of FAs in a like manner.

4. The device of claim 1, wherein
the FA parameter comprises:
a number of the flows that are comprised in the single FA;
a ratio of a maximum size of a packet and link capacity;
a number of hops in a domain through which the FA is passed; and
a maximum number of domains through which the FA is passed.

5. The device of claim 4, wherein
the FA parameter further comprises:
a ratio of a maximum value of the summation of sustainable transfer rates of a plurality of flows in the FA and the link capacity;
a ratio of a maximum value of the summation of sustainable burst size of the plurality of flows in the FA and the link capacity; and
a ratio of a minimum requirement of a service ratio vs. the summation of the sustainable transfer rates or a scheduling priority.

6. The device of claim 5, wherein
the FA parameter further comprises:
a packet discard priority of the FA; and
a class of the FA.

7. A system for managing a network that is controllable per flow aggregate (FA), comprising:
a plurality of FA information management units for generating and managing an FA parameter for displaying control information of the FA;
a plurality of FA information exchange units for receiving the FA parameter from the FA information management unit and storing the same; and
an FA information gathering unit for receiving the FA parameter from the FA information exchange unit and integrating the same as the network information.

8. The system of claim 7, wherein
the plurality of FA information exchange units exchange the FA parameter with each other.

9. The system of claim 7, wherein
the FA information management unit is provided at an edge node of the FA domain.

10. The system of claim 7, wherein
the FA parameter comprises:
a rule for mapping an identifier of a flow on an identifier of an FA;
a bandwidth setting or scheduling method for allocating a bandwidth to the FA;
a number of the flows that are included in the single FA;
a ratio of a maximum size of a packet vs. link capacity;
a number of hops in a domain through which the FA is passed;
a maximum number of domains through which the FA is passed;
a ratio of a maximum value of the summation of sustainable transfer rates of a plurality of flows in the FA and the link capacity;
a ratio of a maximum value of the summation of sustainable burst size of the plurality of flows in the FA and the link capacity;
a ratio of a minimum requirement of a service ratio vs. the summation of the sustainable transfer rates or a scheduling priority;
a packet discard priority of the FA; and
a class of the FA.

11. The system of claim 10, wherein
the mapping rule and the bandwidth setting or scheduling method are applied to a plurality of FAs in a like manner.

12. A management method by a flow aggregate (FA) information exchange unit for managing a domain of the FA in a network that is controllable per FA, comprising:
receiving a request on an FA parameter for indicating control information of the FA from an FA information gathering unit for managing the network;
requesting an FA information management unit belonging in the FA domain on the FA parameter;
receiving the FA parameter from the FA information management unit; and
transmitting the FA parameter to the FA information gathering unit.

13. The management method of claim 12, wherein
the FA parameter is generated by the FA information management unit.

14. The management method of claim 12, wherein
the receiving of a request comprises receiving an identifier of a requester, and
the requesting comprises transmitting an identifier of the requester.

15. The management method of claim 14, wherein
the receiving of a request further comprises receiving an identifier of the FA, and
the requesting further comprises transmitting an identifier of the FA.

16. The management method of claim 12, wherein
the receiving comprises receiving an identifier of a responder.

17. The management method of claim 12, further including
receiving a report on the FA parameter from the FA information management unit; and
reporting the FA parameter to the FA information gathering unit.

18. A management method by a flow aggregate (FA) information exchange unit for managing a domain of the FA in a network that is controllable per FA, comprising:
receiving a report on an FA parameter from the FA information management unit; and
reporting the FA parameter to the FA information gathering unit for managing the network.

19. The management method of claim 18, wherein
the FA parameter is generated by the FA information management unit.

20. The management method of claim 18, wherein
the reporting comprises transmitting an identifier of a reporter.
